(19) United States
(12) Patent Application Publication
(10) Pub. No.: US 2004/0265528 A1
(43) Pub. Date: Dec. 30, 2004

(54) Line, in particular for fuel tank filler systems

(75) Inventors: Marc Van Hooren, Gelnhausen (DE); Wilfried Zulch, Gelnhausen (DE); Andreas Seyler, Gruendau (DE)

Correspondence Address: BURNS DOANE SWECKER & MATHIS L L P, POST OFFICE BOX 1404, ALEXANDRIA, VA, 22313-1404, US

(73) Assignee: VERITAS AG, Gelnhausen (DE)

(21) Appl. No.: 10/837,574

(22) Filed: May 4, 2004

(30) Foreign Application Priority Data
May 5, 2003 (DE) 103 20 224.2

(51) Int. Cl. B32B 1/08

(52) U.S. Cl. 428/36.91

(57) ABSTRACT

The present invention relates to a line, in particular for fuel tank filler systems, which comprises a blocking layer 1 and a cover layer 3. For improving especially the mechanical properties, the blocking layer 1 and the cover layer 3 have provided between them an intermediate layer 2 which is made of nitrile butadiene rubber and which has admixed thereto an adhesion promoter made of a phosphonium compound.

The present invention relates to a line, in particular for fuel tank filler systems, comprising a blocking layer and a cover layer.

Due to statutory provisions (end-of-life vehicle European Directive), only lead-free fuel tank filler systems may be offered in the near future. Hence, lead-free multilayer fuel lines comprising a permeation-inhibiting inliner as a blocking layer and a cover layer, which surrounds said blocking layer, are already produced. The blocking layer prevents undesired permeation of the fuel contained in the line. Substances used as materials which produce a particularly good blocking effect are in particular fluorothermoplasts and also polyamide-based plastics. Materials used as a cover layer are rubber-based materials, such as epichlorohydrine rubber, which are particularly resistant to environmental influences and heat.

In view of the fact that fluorothermoplasts have very poor adhesion properties, it is difficult to establish between the blocking layer and the cover layer a frictional connection which is resistant to mechanical loads. A solution of this problem which has been practiced up to now is the use of an adhesive or of a surface treatment (plasma etc.) between the blocking layer and the cover layer. This, however, makes it more difficult to produce the fuel line.

In order to avoid the use of an adhesive, U.S. Pat. No. 6,037,062 suggests that the cover layer, which is made of epichlorohydrine rubber, should have admixed thereto an organic phosphonium compound as an adhesion promoter. Making use of the above-mentioned adhesion promoter, the cover layer is frictionally connected directly to the blocking layer, without the adhesive that is normally used, so as to form a two-layered fuel hose.

It is the object of the present invention to provide a reasonably-priced line, in particular for fuel tank filler systems, which comprises a blocking layer and a cover layer and which is able to resist high mechanical loads and produces simultaneously a good blocking effect against the medium conducted in the line, in particular against methanol-containing fuel.

According to the present invention, this object is achieved by a line comprising a blocking layer and a cover layer, said blocking layer and said cover layer having provided between them an intermediate layer which is made of nitrile butadiene rubber and which has admixed thereto an adhesion promoter made of a phosphonium compound.

Other than in the case of the prior art, the adhesion promoter is admixed not to the cover layer but to an intermediate layer which is provided between the cover layer and the blocking layer and which is made of nitrile butadiene rubber (NBR). By admixing a phosphonium compound, the adhesion between the blocking layer and the intermediate layer will be improved so that a particularly firm connection can be established between the blocking layer and the intermediate layer. The connection between the cover layer and the intermediate layer is less problematic so that, on the whole, a multilayered line will be obtained whose individual layers will, in comparison with the multilayered lines known from the prior art, adhere better to one another and will therefore be connected more firmly to one another.

It proved to be particularly advantageous when the adhesion promoter comprises 80% to less than 100% of tetrabutyl phosphonium benzotriazolate. Such a phosphonium compound will lead to a particularly good adhesion behaviour between the blocking layer and the intermediate layer.

According to a preferred embodiment, the blocking layer is produced from at least one fluorothermoplast, in particular from PVDF and/or THV. The materials referred to produce an excellent blocking effect against easily volatilizing fuels and are therefore particularly suitable for producing the blocking layer.

According to another preferred embodiment, the blocking layer is produced from at least one polyamide, in particular from PA12. The use of a polyamide-based material for producing the blocking layer allows the production of particularly low-priced lines.

In addition, it proved to be particularly advantageous when the cover layer is produced from chloropolyethylene. This material has particularly good protection properties so that a line comprising such a cover layer will be particularly resistant to environmental influences and heat.

According to another embodiment, the line comprises three layers. It turned out that a three-layered line which comprises the blocking layer, the intermediate layer and the cover layer, the intermediate layer being produced from nitrile butadiene rubber which has admixed thereto an adhesion promoter consisting of a phosphonium compound, satisfies the strict statutory demands on the admissible permeation rate and the necessary strength.

When a medium is to be conducted under elevated pressures in said line, a reinforcement layer can be provided according to a preferred embodiment, said reinforcement layer being provided especially between the cover layer and the intermediate layer. This reinforcement layer acts as a pressure carrier and enlarges the possibilities of use of the line according to the present invention as far as the pressure range is concerned.

In the following, the present invention will be explained exemplarily and with regard to further details making reference to schematic drawings, in which

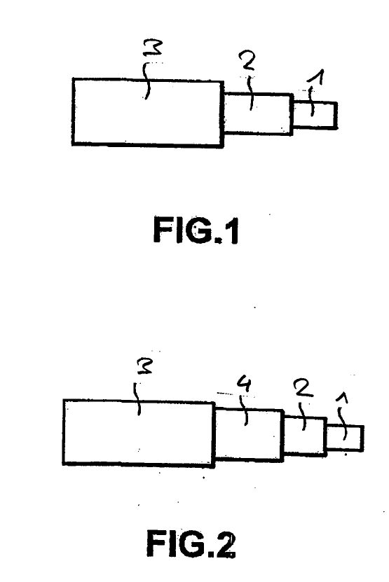

FIG. 1 shows a side view of a three-layered embodiment of the line according to the present invention and

FIG. 2 shows a side view of a four-layered embodiment of the line according to the present invention.

FIG. 1 shows a side view of an embodiment of the line according to the present invention, said line being predominantly used as a fuel line in fuel tank filler systems. In order to make the arrangement of the individual layers more easily understandable the outer layers, which cover the inner layers, are shown only partly.

The inliner of the line is implemented as a blocking layer 1 which, in the present embodiment, is in direct contact with the fuel conducted in said line. This blocking layer is produced from a fluorothermoplast. Substances which are particularly suitable to be used as fluorothermoplasts are tetrafluoroethylene hexafluoropropylene vinylidene fluoride (THV) or polyvinylidene fluoride (PVDF). These materials have particularly good permeation-inhibiting properties. Alternatively, the blocking layer 1 can be produced from at least one polyamide, in particular from PA12; this is a low-priced alternative to the use of the fluorothermoplast.

As can be seen in FIG. 1, the blocking layer 1 is surrounded by an intermediate layer 2, which is positively and frictionally connected to said blocking layer 1 and which is produced from acryl-nitrile butadiene rubber (NBR). The good adherence of the intermediate layer 2 to the blocking layer 1 is achieved by admixing an adhesion promoter made of a phosphonium compound. In the present embodiment, the adhesion promoter comprises 80% to less than 100% tetrabutyl phosphonium benzotriazolate. The use of such an adhesion promoter leads to a particularly firm connection between the intermediate layer 2 and the blocking layer 1. The above-mentioned phosphonium compound can be admixed in an amount of 0.5 to approx. 5% by weight, depending on the respective strength properties and the respective vulcanization rate desired. The intermediate layer 2 may additionally contain 0.1 up to approx. 5% by weight of a vulcanizing agent. Apart from the above-mentioned additives, the intermediate layer may fully consist of NBR or of a mixture of NBR and of other materials, especially other types of rubber. The addition of other additives is possible as well.

The outer layer of the line shown in FIG. 1 forms a cover layer 3 produced from chloropolyethylene. Also the cover layer 3 is positively and frictionally connected to the intermediate layer 2. The connection between the cover layer 3 and the intermediate layer 2 is unproblematic as far as the adhesive effect is concerned.

The line shown in FIG. 1 is produced by coextrusion. Other production methods are imaginable well.

For cases of use where the fuel is transported under elevated pressure, a reinforcement layer 4 is provided as a pressure carrier between the cover layer 3 and the intermediate layer 2, as can be seen in FIG. 2. This reinforcement layer 4 can be implemented as a layer of fabric. Depending on the respective case of use of the line, additional layers can be provided, e.g. as a special heat protection.

The above-described line is particularly suitable for use as a fuel hose in fuel tank filler systems. Other possibilities of using these lines in fields of application where easily volatilizing media have to be transported through lines are imaginable as well.

1. A line, in particular for fuel tank filler systems, comprising a blocking layer and a cover layer, wherein the blocking layer and the cover layer have provided between them an intermediate layer which is made of nitrile butadiene rubber and which has admixed thereto an adhesion promoter made of a phosphonium compound.

2. A line according to claim 1, wherein the adhesion promoter comprises 80% to less than 100% of tetrabutyl phosphonium benzotriazolate.

3. A line according to claim 1, wherein the blocking layer is produced from at least one fluorothermoplast, in particular from PVDF and/or THV.

4. A line according to claim 1, wherein the blocking layer is produced from at least one polyamide, in particular from PA12.

5. A line according to claim 1, wherein the cover layer is produced from chloropolyethylene.

6. A line according to claim 1, wherein the line comprises three layers.

7. A line according to claim 1, wherein a reinforcement layer is provided, said reinforcement layer being provided especially between the cover layer and the intermediate layer.
